(19) United States
(12) Patent Application Publication
(10) Pub. No.: US 2013/0218879 A1
(43) Pub. Date: Aug. 22, 2013

(54) UPDATE SYSTEMS OF SPACE OF INTEREST DATA AND METHODS THEREOF

(71) Applicants: Cheol-Woo Park, Seoul (KR); Jin-Keun Park, Seoul (KR)

(72) Inventors: Cheol-Woo Park, Seoul (KR); Jin-Keun Park, Seoul (KR)

(73) Assignee: HYUNDAI MOTOR COMPANY, Seoul (KR)

(21) Appl. No.: 13/618,488

(22) Filed: Sep. 14, 2012

Related U.S. Application Data
(63) Continuation-in-part of application No. 13/320,649, filed on Nov. 15, 2011.
(60) Provisional application No. 61/591,173, filed on Jan. 26, 2012.

(30) Foreign Application Priority Data
May 15, 2009 (KR) 10-2009-0042401

(51) Int. Cl. G06F 17/30

(52) U.S. Cl. CPC G06F 17/30241
USPC 707/724

(57) ABSTRACT

An aspect of the invention provides a system including: an SOI database that stores registered SOI data; a geographical information similarity determination module that determines if there is at least one set of registered SOI data whose geographical information is the same as or similar to that of the new SOI data by comparing the geographical information of the new SOI data and the geographical information of the registered SOI data; and an SOI database registration module that merges the registered SOI data of the SOI database with the geographical information or the non-geographical information of the new SOI data and stores the merged data in the SOI database if there is a set of registered SOI data whose geographical information is the same as or similar to that of the new SOI data as a result of determination of the geographical information similarity determination module.

### CROSS-REFERENCE TO RELATED APPLICATIONS

This application claims priority under 35 U.S.C. §119(e) to U.S. Provisional Patent Application Ser. No. 61/591,173, filed Jan. 26, 2012. This application is also a continuation-in-part under 35 U.S.C. §120 of U.S. patent application Ser. No. 13/320,649, filed Nov. 15, 2011, which is a national phase application under 35 U.S.C. §371 of International Application No. PCT/KR2010/003055, filed May 14, 2010, which claim priority to Korean Patent Application No. 10-2009-0042401, filed May 15, 2009. The entire content of each of the above-referenced patent applications is hereby incorporated by reference herein.

### FIELD OF THE INVENTION

The present invention relates to a system and method for updating space of interest (SOI) data, and more particularly, to a system and method for updating SOI data capable of adaptively determining whether to merge new SOI data with the existing SOI data or to register as new input SOI data in consideration of geographical and non-geographical information, and processing the new input SOI data accordingly. A space of interest (SOI) refers to a collection of data about a space of people's interest or use. An SOI is made up of point, line and/or plane and has a unique identifying data.

### BACKGROUND OF THE INVENTION

In the case of a map-based information providing service and a navigation service, etc. that provide geographical information, space occupied by facilities such as a government office and an educational institution is specified as an area or coordinates in the map, and information of the facility such as the phone number, name and other details, etc. can be provided. However, the system that provides such geographical information often provides a wide area service for one country or a number of countries. For such a system, hundreds of thousands of sets of SOI exist, and the locations, names and phone numbers of facilities indicated by each SOI are changed constantly. Hence, in order to provide accurate geographical information, each SOI should be updated with geographical or non-geographical information quickly.

However, according to a conventional data update system, a general user or a manager manually checks the change of the SOI data and reflects the change in the database, and thus, many people are required do the updating work, thereby increasing costs for providing the service and making it difficult to perform a quick data update.

### SUMMARY OF THE INVENTION

The present invention has been made in view of the above problems and provides a system and method for updating SOI data capable of reducing time and costs that are used in updating SOI data by automatically determining whether to merge new SOI data with the existing registered SOI data or to register the new SOI data as new registered SOI data through an algorithm that determines similarity between the registered SOI data and geographical information and non-geographical information by processing new SOI data obtained through various routes.

An aspect of the invention provides a system for updating space of interest (SOI) data including: an SOI database that stores registered SOI data that is SOI data generated from geographical information with non-geographical information; one or more modules selected from the group consisting of: a data receiving module and an external database, wherein the module that provides new SOI data generated from geographical information; a geographical information similarity determination module that determines if there is at least one set of registered SOI data whose geographical information is the same as or similar to that of the new SOI data by comparing the geographical information of the new SOI data and the geographical information of the registered SOI data; and an SOI database registration module that merges the registered SOI data of the SOI database with the geographical information or the non-geographical information of the new SOI data and stores the merged data in the SOI database if there is a set of registered SOI data whose geographical information is the same as or similar to that of the new SOI data as a result of determination of the geographical information similarity determination module.

The registered SOI data can include SOI data generated by mapping geographical information with non-geographical information and the new SOI data can be generated by mapping geographical information with non-geographical information.

The system can further include a non-geographical information similarity determination module that determines similarity of non-geographical information between the non-geographical information of the new SOI data whose similarity has been confirmed by the geographical information similarity determination module and non-geographical information of the at least one registered SOI data containing the same geographical information.

The SOI database registration module can store the new SOI data as new registered SOI data in the SOI database if there is no registered SOI data whose geographical information is the same as that of the new SOI data as a result of determination of the geographical information similarity determination module.

The geographical information can include coordinates information and the geographical information similarity determination module can further include a coordinates information similarity determination unit that determines similarity between the coordinates information of the new SOI data and the coordinates information of the registered SOI data.

The geographical information can include address information, and the geographical information similarity determination module can further include an address information similarity determination unit that determines similarity between the address information of the new SOI data and the address information of the registered SOI data.

The geographical information can include coordinates information and the geographical information similarity determination module can further include a shape similarity determination unit that determines similarity between a new shape defined by the coordinates information of the new SOI data and an old shape defined by the coordinates information of the registered SOI data.

The non-geographical information can include phone number information and name information, the non-geographical information similarity determination module can further include: a phone number identity determination unit that determines identity between the phone number information of the new SOI data and the phone number information of the registered SOI data and a name information similarity determination unit that determines similarity between the name information of the new SOI data and the name information of the registered SOI data, and the SOI database registration module can merge the registered SOI data of the SOI database with the geographical information or the non-geographical information of the new SOI data and stores the merged data in the SOI data if there is a set of registered SOI data whose phone number information is the same as that of the new SOI data or whose name information is similar to or the same as that of the new SOI data as a result of determination of the phone number identity determination unit or the name information similarity determination unit.

The system can further include a reference database including synonym dictionary data and the name information similarity determination unit can determine similarity with reference to synonym dictionary data of the reference data.

The SOI data update system can further include an external database data normalization module that normalizes input SOI data inputted through the external database system to conform to the data format of the registered SOI data stored in the SOI database.

The SOI database registration module can also merge relation information and property information of SOI data and contents when merging the registered SOI data with the new SOI data.

The SOI database registration module can compare generation time of the registered SOI data with that of the new SOI data and merges recent data when merging the registered SOI data of the SOI database with the new SOI data.

The new SOI data can include coordinates for a point.

The geographic information similarity determination module can determines if there is at least one set of registered SOI data whose geographic information is the same or similar to that of the new SOI data by determining whether the coordinates for the point lie within a space defined by at least one set of registered SOI data.

In another embodiment, if the coordinates for the point do not lie within a space defined by at least one set of registered SOI data, the geographic information similarity determination module further determines if there is at least one set of registered SOI data whose geographic information is the same or similar to that of the new SOI data by determining whether the coordinates for the point lie within a buffer surrounding a space defined by at least one set of registered SOI data.

In another embodiment, if the coordinates for the point do not lie within a space defined by at least one set of registered SOI data, the geographic information similarity determination module further determines if there is at least one set of registered SOI data whose geographic information is the same or similar to that of the new SOI data by determining computing a probability that the point lies within a space defined by at least one set of registered SOI data.

In another embodiment, the new SOI data includes address information.

In another embodiment, the geographic information similarity determination module determines if there is at least one set of registered SOI data whose geographic information is the same or similar to that of the new SOI data by determining whether the address information for the point is the same or similar to address information associated with at least one set of registered SOI data.

Another aspect of the invention provides a system for updating space of interest (SOI) data. The system includes: an SOI database that stores registered SOI data that is SOI data generated by mapping geographical information with non-geographical information; one or more module selected from the group consisting of: (i) a data receiving module and (ii) an external database, wherein the module that provides new SOI data generated from geographical information; a non-geographical information similarity determination module that determines if there is at least one set of registered SOI data whose non-geographical information is the same as or similar to that of the new SOI data by comparing the non-geographical information of the new SOI data and the non-geographical information of the registered SOI data; and an SOI database registration module that merges the registered SOI data of the SOI database with the geographical information or the non-geographical information of the new SOI data and stores the merged data in the SOI database if there is a set of registered SOI data whose non-geographical information is the same as or similar to that of the new SOI data as a result of determination of the non-geographical information similarity determination module.

The system can further include a geographical information similarity determination module that determines similarity of geographical information between the geographical information of the new SOI data whose similarity has been confirmed by the non-geographical information similarity determination module and geographical information of the at least one registered SOI data containing the same non-geographical information.

In another embodiment, the SOI database registration module stores the new SOI data as new registered SOI data in the SOI database if there is no registered SOI data whose non-geographical information is the same as that of the new SOI data as a result of determination of the non-geographical information similarity determination module.

In another embodiment, the geographical information includes coordinates information, and the geographical information similarity determination module further includes a coordinates information similarity determination unit that determines similarity between the coordinates information of the new SOI data and the coordinates information of the registered SOI data.

In another embodiment, the geographical information includes address information and the geographical information similarity determination module further includes an address information similarity determination unit that determines similarity between the address information of the new SOI data and the address information of the registered SOI data.

In another embodiment, the non-geographical information includes phone number information and name information, the non-geographical information similarity determination module further includes: a phone number identity determination unit that determines identity between the phone number information of the new SOI data and the phone number information of the registered SOI data and a name information similarity determination unit that determines similarity between the name information of the new SOI data and the name information of the registered SOI data, and wherein the SOI database registration module merges the registered SOI data of the SOI database with the geographical information or the non-geographical information of the new SOI data and stores the merged data in the SOI data if there is a set of registered SOI data whose phone number information is the same as that of the new SOI data or whose name information is similar to or the same as that of the new SOI data as a result of determination of the phone number identity determination unit or the name information similarity determination unit.

In another embodiment, the SOI data update system further comprises a reference database including synonym dictionary data and the name information similarity determination unit determines similarity with reference to synonym dictionary data of the reference data.

In another embodiment, the SOI data update system further comprises an external database system including SOI data, and an external database data normalization module that normalizes input SOI data inputted through the external database system to conform to the data format of the registered SOI data stored in the SOI database.

In another embodiment, the SOI database registration module also merges relation information and property information of SOI data and contents when merging the registered SOI data with the new SOI data.

In another embodiment, the SOI database registration module compares generation time of the registered SOI data with that of the new SOI data and merges recent data when merging the registered SOI data of the SOI database with the new SOI data.

In another embodiment, the new SOI data includes coordinates for a point.

In another embodiment, the geographic information similarity determination module determines if there is at least one set of registered SOI data whose geographic information is the same or similar to that of the new SOI data by determining whether the coordinates for the point lie within a space defined by at least one set of registered SOI data.

In another embodiment, if the coordinates for the point do not lie within a space defined by at least one set of registered SOI data, the geographic information similarity determination module further determines if there is at least one set of registered SOI data whose geographic information is the same or similar to that of the new SOI data by determining whether the coordinates for the point lie within a buffer surrounding a space defined by at least one set of registered SOI data.

In another embodiment, if the coordinates for the point do not lie within a space defined by at least one set of registered SOI data, the geographic information similarity determination module further determines if there is at least one set of registered SOI data whose geographic information is the same or similar to that of the new SOI data by determining computing a probability that the point lies within a space defined by at least one set of registered SOI data.

In another embodiment, the new SOI data includes address information.

In another embodiment, the geographic information similarity determination module determines if there is at least one set of registered SOI data whose geographic information is the same or similar to that of the new SOI data by determining whether the address information for the point is the same or similar to address information associated with at least one set of registered SOI data.

Another aspect of the invention provides a method for updating SOI data. The method includes: receiving an input of input SOI data that is generated by mapping geographical information with non-geographical information (step 1); determining whether there is a set of registered SOI data containing geographical information that is the same as or similar to that of the input SOI data by comparing the input SOI data with the registered SOI data stored in the SOI database (step 2); determining if there is a set of data containing geographical information that is the same as or similar to that of the input SOI data as a result of determination of step 2, and otherwise deferring registration of the new SOI data (step 3); and merging the registered SOI data with the geographical information or non-geographical information of the input SOI data if the geographical information of the input SOI data is the same as or similar to that of the registered SOI data as a result of determination at step 3, and storing the merged data in the SOI database (step 4).

The method can include determining identity or similarity between non-geographical information of the input SOI data whose similarity has been confirmed, and the non-geographical information of the registered SOI data having geographical information that is the same as or similar to that of the input SOI data (step 3b).

The method can include storing the input SOI data as new registered SOI data in the SOI database if the non-geographical information of the input SOI data is dissimilar to that of the registered SOI data as a result of determination at step 3b, after step 4 (step 5).

In another embodiment, the geographical information includes coordinates information and address information, step 2 comprises: determining whether there is the coordinates information in the input SOI data (sub-step 1); determining whether there is registered SOI data having coordinates information that is the same as or similar to that of the input SOI data if there is the coordinates in the input SOI data as a result of determination at sub-step 1; and determining whether there is a set of registered SOI data having the address information that is the same as or similar to that of the new SOI data if there is no coordinates information in the input SOI data as a result of determination at sub-step 1 or if there is no registered SOI data whose coordinates information is the same as or similar to that of the new SOI data as a result of determination at sub-step 2, and step 3 confirms similarity for the input SOI data if there is a set of registered SOI data whose coordinates information or address information is the same as or similar to that of the input SOI data.

In another embodiment, the non-geographical information includes phone number information and address information, step 3b comprises: determining whether there is a set of registered SOI data having phone number information that is the same as that of the input SOI data (sub-step 4); and determining whether there is a set of registered SOI data having name information that is the same as or similar to that of the input SOI data if there is no registered SOI data having phone number information that is the same as that of the input SOI data as a result of determination at sub-step 4 (sub-step 5), step 4 merges the registered SOI data with the geographical information or non-geographical information of the input SOI data, and stores the merged data in the SOI database if the phone number information of the input SOI data is the same as that of the registered SOI data or the name information of the input SOI data is the same as or similar to that of the registered SOI data as a result of determination at step 3b.

In another embodiment, step 4 determines similarity of the name information with reference to synonym dictionary data.

In another embodiment, step 1 further comprises normalizing the input SOI data to conform to the data format of the registered SOI data stored in the SOI database (sub-step 6).

Another aspect of the invention provides a method for updating SOI data. The method includes: receiving an input of input SOI data that is generated by mapping geographical information with non-geographical information (step 1); determining whether there is a set of registered SOI data containing non-geographical information that is the same as or similar to that of the input SOI data by comparing the input SOI data with the registered SOI data stored in the SOI database (step 2); determining if there is a set of data containing non-geographical information that is the same as or similar to that of the input SOI data as a result of determination of step 2, and otherwise deferring registration of the new SOI data (step 3); and merging the registered SOI data with the geographical information or non-geographical information of the input SOI data if the non-geographical information of the input SOI data is the same as or similar to that of the registered SOI data as a result of determination at step 3, and storing the merged data in the SOI database (step 4).

The method can further include determining identity or similarity between geographical information of the input SOI data whose similarity has been confirmed, and the geographical information of the registered SOI data having non-geographical information that is the same as or similar to that of the input SOI data (step 3b).

The method can further include storing the input SOI data as new registered SOI data in the SOI database if the geographical information of the input SOI data is dissimilar to that of the registered SOI data as a result of determination at step 3b, after step 4 (step 5).

In another embodiment, the geographical information includes coordinates information and address information, step 2 comprises: determining whether there is the coordinates information in the input SOI data (sub-step 1); determining whether there is registered SOI data having coordinates information that is the same as or similar to that of the input SOI data if there is the coordinates in the input SOI data as a result of determination at sub-step 1; and determining whether there is a set of registered SOI data having the address information that is the same as or similar to that of the new SOI data if there is no coordinates information in the input SOI data as a result of determination at sub-step 1 or if there is no registered SOI data whose coordinates information is the same as or similar to that of the new SOI data as a result of determination at sub-step 2, and step 3 confirms similarity for the input SOI data if there is a set of registered SOI data whose coordinates information or address information is the same as or similar to that of the input SOI data.

In another embodiment, the geographical information includes phone number information and address information, step 3 comprises: determining whether there is a set of registered SOI data having phone number information that is the same as that of the input SOI data (sub-step 4); and determining whether there is a set of registered SOI data having name information that is the same as or similar to that of the input SOI data if there is no registered SOI data having phone number information that is the same as that of the input SOI data as a result of determination at sub-step 4 (sub-step 5), step 4 merges the registered SOI data with the geographical information or non-geographical information of the input SOI data, and stores the merged data in the SOI database if the phone number information of the input SOI data is the same as that of the registered SOI data or the name information of the input SOI data is the same as or similar to that of the registered SOI data as a result of determination at step 3.

In another embodiment, step 3 determines similarity of the name information with reference to synonym dictionary data.

In another embodiment, step 1 further comprises normalizing the input SOI data to conform to the data format of the registered SOI data stored in the SOI database (sub-step 6).

The method can include receiving an input of input SOI data that is generated by mapping geographical information with non-geographical information (step 1); determining whether there is a set of registered SOI data containing geographical and non-geographical information that is the same as or similar to that of the input SOI data by comparing the input SOI data with the registered SOI data stored in the SOI database (step 2); and merging the registered SOI data with the geographical information or non-geographical information of the input SOI data if the geographical information and non-geographical information of the input SOI data is the same as or similar to that of the registered SOI data as a result of determination at step 2, and storing the merged data in the SOI database (step 3).

Another aspect of the invention provides a system for updating space of interest (SOI) data. The system includes: an SOI database that stores registered SOI data that is SOI data generated by mapping geographical information with non-geographical information; one or more module selected from the group consisting of: (i) a data receiving module and (ii) an external database, wherein the module that provides new SOI data generated from geographical information; an information similarity determination module that determines if there is at least one set of registered SOI data whose geographical information and non-geographical information is the same as or similar to that of the new SOI data by comparing the geographical information and non-geographical information of the new SOI data and the geographical information and non-geographical information of the registered SOI data; and an SOI database registration module that merges the registered SOI data of the SOI database with the geographical information or the non-geographical information of the new SOI data and stores the merged data in the SOI database if there is a set of registered SOI data whose geographical information and non-geographical information is the same as or similar to that of the new SOI data as a result of determination of the information similarity determination module.

Another aspect of the invention provides a computer program product for causing a computer to perform a method for updating SOI data. The computer program product includes computer-usable medium having control logic stored therein that, when executed by a processor, is operable to: receive an input of input SOI data that is generated by mapping geographical information with non-geographical information (step 1); determine whether there is a set of registered SOI data containing geographical information that is the same as or similar to that of the input SOI data by comparing the input SOI data with the registered SOI data stored in the SOI database (step 2); determine if there is a set of data containing geographical information that is the same as or similar to that of the input SOI data as a result of determination of step 2, and otherwise deferring registration of the new SOI data (step 3); and merge the registered SOI data with the geographical information or non-geographical information of the input SOI data if the geographical information of the input SOI data is the same as or similar to that of the registered SOI data as a result of determination at step 3, and storing the merged data in the SOI database (step 4).

Another aspect of the invention provides a computer program product for causing a computer to perform a method for updating SOI data. The computer program product includes computer-usable medium having control logic stored therein that, when executed by a processor, is operable to: receive an input of input SOI data that is generated by mapping geographical information with non-geographical information (step 1); determine whether there is a set of registered SOI data containing non-geographical information that is the same as or similar to that of the input SOI data by comparing the input SOI data with the registered SOI data stored in the SOI database (step 2); determine if there is a set of data containing non-geographical information that is the same as or similar to that of the input SOI data as a result of determination of step 2, and otherwise deferring registration of the new SOI data (step 3); and merge the registered SOI data with the geographical information or non-geographical information of the input SOI data if the non-geographical information of the input SOI data is the same as or similar to that of the registered SOI data as a result of determination at step 3, and storing the merged data in the SOI database (step 4).

Another aspect of the invention provides a computer program product for causing a computer to perform a method for updating SOI data. The computer program product includes computer-usable medium having control logic stored therein that, when executed by a processor, is operable to: receive an input of input SOI data that is generated by mapping geographical information with non-geographical information (step 1); determine whether there is a set of registered SOI data containing geographical and non-geographical information that is the same as or similar to that of the input SOI data by comparing the input SOI data with the registered SOI data stored in the SOI database (step 2); and merge the registered SOI data with the geographical information or non-geographical information of the input SOI data if the geographical information and non-geographical information of the input SOI data is the same as or similar to that of the registered SOI data as a result of determination at step 2, and storing the merged data in the SOI database (step 3).

### BRIEF DESCRIPTION OF THE DRAWINGS

The objects, features and advantages of the present invention will be more apparent from the following detailed description in conjunction with the accompanying drawings, in which:

FIG. 1 illustrates the constitution of a system for updating space of interest (SOI) data according to an exemplary embodiment of the present invention;

FIG. 2 is a flowchart illustrating a method for updating SOI data according to an exemplary embodiment of the present invention; and

FIGS. 3A and 3B illustrate the constitution of systems for updating space of interest (SOI) data according to further exemplary embodiments of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

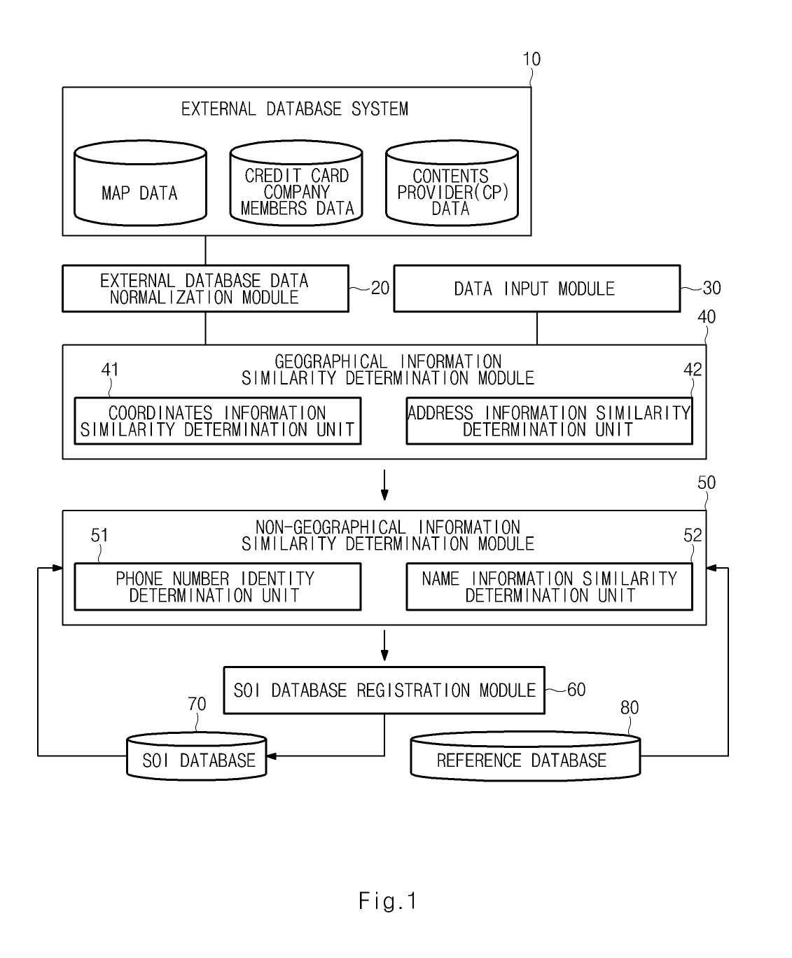

FIG. 1 illustrates the constitution of a system for updating space of interest (SOI) data according to an exemplary embodiment of the present invention. The system for updating SOI data according to the present invention includes an SOI database 70, a data receiving module 30, a geographical information similarity determination module 40, a non-geographical information similarity determination module 50, and an SOI DB registration module 60.

The SOI database 70 stores registered SOI data that includes mapped geographical information with non-graphical information. Geographical information of SOI data can include coordinates information and address information, and non-geographical information can include information such as phone number and name. That is, the SOI data refers to a geographical information specifying space in the map that is mapped with non-geographical information related to the space.

The data receiving module 30 receives the new SOI data of the geographical information mapped with non-geographical information. The data receiving module 30 is implemented by an input means such as a keyboard and a touchpad, etc., and can be implemented so that user or administrator can manually input SOI data.

Preferably, the data receiving module 30 can be constituted so that new data can be inputted through an external database by allowing data interlocking with the external database. According to an exemplary embodiment of the present invention, the system for updating SOI data further includes an external database system 10 including map data, credit card company members data, contents provider (CP) data, and an address directory, etc., and further includes an external database normalization module that normalizes input SOI data inputted through the external database system 10 so that the input SOI data conforms to the data format of the registered SOI data.

The data provided through the external database system 10 can have a format that is different from that of the SOI database 70. In such a case, the problem of redundantly managing the same data by considering the same data to be different by normalizing in the same format can be resolved. For example, in the case of a phone number, if the SOI database 70 stores the phone number as 02-555-5555 and the external database (DB) system 10 stores the phone number as 02)555-5555, the external DB data normalization module 20 converts the phone number information format of input SOI data imported through the external DB system 10 to conform to the phone number information format of the SOI database 70.

The geographical information similarity determination module 20 compares geographical information of new SOI data inputted through the data receiving module 30 or the external DB data normalization module 20 with geographical information registered SOI data stored in the SOI database and confirms the space for the new SOI data if there is at least one set of registered SOI data whose geographical information is the same as or similar to the geographical information of the new SOI data. That is, the geographical information similarity determination module 20 determines whether the newly inputted new SOI data is overlapped with or renews the existing SOI data already stored in the SOI database or relates to new information for the space that has not yet been defined and confirms the space specified by the new SOI data.

Specifically, it is preferable that geographical information includes coordinates information and address information, and the geographical information similarity determination module 20 further includes a coordinates information similarity determination unit 41 that determines similarity of coordinates information of new SOI data and coordinates information of registered SOI data, and an address information similarity determination unit 42 that determines similarity of address information of registered SOI data. Here, if there is at least one set of registered SOI data whose coordinates information or address information is the same as or similar to that of new SOI data, the space for the new SOI data is confirmed.

The non-geographical information similarity determination module 50 determines similarity of non-geographical information between non-geographical information of new SOI data, whose space has been confirmed by the geographical information similarity determination module 40 and at least one set of registered SOI data having geographical information that is the same as that of the new SOI data. In the case of a large building, a plurality of geographical objects having different non-geographical information can share the same geographical information. The non-geographical information similarity determination module 50 determines registered SOI data that is substantially the same as new SOI data among a plurality of sets of registered SOI data sharing the same geographical information with the new SOI data.

Specifically, if non-geographical information includes phone number information and name information, the non-geographical information similarity determination module 50 further includes a phone number identity determination unit 51 that determines identity between phone number information of new SOI data and phone number information of registered SOI data, and a name information similarity determination unit 52 that determines similarity of name information of registered SOI data.

The name information similarity determination unit 52 can be implemented to determine similarity in name by applying the existing similarity determination algorithm or to determine similarity of name information with reference to synonym dictionary data of the reference database 70 including synonym dictionary data. Some examples of the similarity determination algorithm are Levenshtein Distance algorithm, Boyer-Moore algorithm, and Aho Corasick algorithm, etc.

According to an exemplary embodiment of the present invention, unique similarity determination criteria of the present invention can be utilized by applying a statistical method by measuring similarity through a similarity determination algorithm.

As a result of determination of the non-geographical information similarity determination module 50, if there is SOI data whose non-geographical information is the same as or similar to that of new SOI data, the SOI database registration module 60 merges geographical information or non-geographical information of new SOI data with registered SOI data of SOI database and stores the merged data in the SOI database. In the case of an exemplary embodiment including name information phone number information as non-geographical information, if there are new SOI data and registered SOI data whose name information or phone number information are the same or similar to each other, the new SOI data and the registered SOI data are merged.

Preferably, as a result of determination of the non-geographical information similarity determination module 50, if that there is no registered SOI data whose non-geographical information is the same as that of new SOI data, the SPI database registration module 60 stores new SOI data in the SOI database 70 as new registered SOI data.

For example, it is assumed that according to the registered SOI data, the name information is “ABC Chocolates”, there is no phone number information, the address information is “650 10^{th} Avenue, New York”, and there is no floor information, and according to new SOI data, the name is information is “ABC Chocolates”, the phone number is “212-664-1258”, the address information is “650 10^{th} Avenue, New York”, and the floor information is the “first floor”. First, the external DB data normalization module 20 normalizes “New York” of the address information of the new SOI data to “New York City” for smooth processing of data. Thereafter, the address information similarity determination unit 42 of the geographical information similarity determination module 40 confirms the space for new SOI data by checking whether the address information of the two sets of SOI data is the same. Thereafter, the name information similarity determination unit 52 of the non-geographical information similarity determination module 50 determines similarity between “ABC Chocolates” and “ABC Chocolatier”, and decides similarity using a method such as Levenstein distance algorithm or synonym dictionary search, etc. Lastly, the SOI database registration module 60 updates non-inputted phone number information and floor information of registered SOI data to the information of new SOI data.

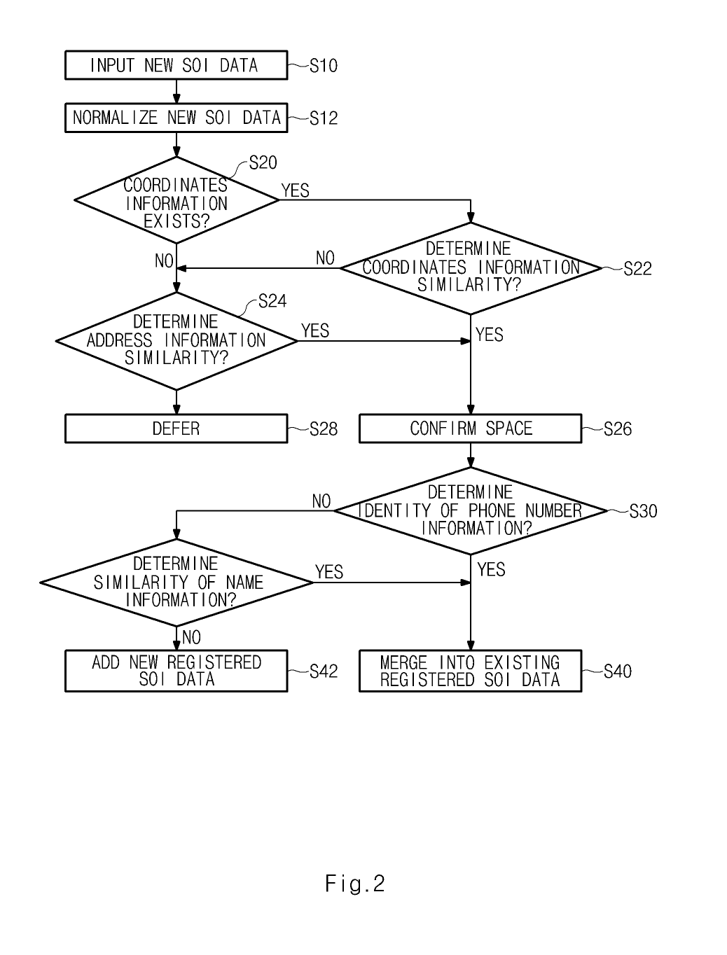

FIG. 2 is a flowchart illustrating a method for updating SOI data according to an exemplary embodiment of the present invention.

First, input SOI data, that maps geographical information with non-geographical information, is inputted at step 1 (S10). Here, it is preferable that step 1 (S10) further includes sub-step 6(S12) that normalizes input SOI data to conform to the data format of the registered SOI data stored in the SOI database.

Next, the input SOI data and the registered SOI data stored in the SOI database 70 are compared, and it is determined whether there is registered SOI data having geographical information that is the same as or similar to the geographical information of the input SOI data at step 2 (S20, S22, S24).

Next, as a result of determination at step 2, if there is registered SOI data having geographical information that is the same as or similar to the geographical information of the input SOI data, the space for the input SOI data is confirmed, but otherwise the registration of new SOI data is deferred at step 3 (S26, S28). If the registration of new SOI data is deferred (S28), it is determined whether a new address has been set, and registration process can be resumed.

At this time, if geographical information contains coordinates information and address information, step 2 includes:
sub-step 1 (S20) that determines whether coordinates information exists in new SOI data,
sub-step 2 (S22) that determines whether there is registered SOI data having coordinates information that is the same as or similar to the coordinates information of new SOI data if there is coordinates information in the new SOI data as a result of determination of sub-step 1, and
sub-step 3 that determines whether there is registered SOI data having address information that is the same as or similar to the address information of new SOI data if there is no coordinates information in new SOI data as a result of determination at step 1 (S20) or if there is no registered SOI data having coordinates information that is the same as or similar to the coordinates information of new SOI data as a result of determination at step 2 (S22).
   Step 3 (S26, S28) confirms the space for input SOI data if there is registered SOI data having at least one of coordinates information and address information that is the same as or similar to that of input SOI data.

Next, identity or similarity between non-geographical information of input SOI data whose space has been confirmed at step 3 and non-geographical information of registered SOI data having geographical information that is the same as or similar to the geographical information of input SOI data is determined at step 4 (S30, S32). Unlike step 3 that determines similarity of geographical information between new SOI data and all registered SOI data of the SOI database, step 4 determines similarity of non-geographical information only between new SOI data and registered SOI data having geographical information that is the same as that of the data.

As a result of determination of step 4, if non-geographical information of input SOI data is the same as or similar to that of registered SOI data, the geographical information or non-geographical information of new SOI data is merged into registered SOI data, and the merged data is registered in the SOI database 70 at step 5 (S40).

Preferably, as a result of determination of step 4, if non-geographical information of input SOI data is dissimilar to that of registered SOI data after step 5, new SOI data is stored in SOI database 70 as new registered SOI data at step 6 (S42).

Further, in the case of an example that non-geographical information includes phone number information and name information, step 4 comprises sub-step 4 (S30) that determines whether there is registered SOI data having phone number information that is the same as that of new SOI data, and sub-step 5 that determines whether there is registered SOI data having name information that is the same as or similar to the name information of new SOI data if there is no registered SOI data having phone number information that is the same as or similar to that of new SOI data as a result of determination at sub-step 4. As a result of determination of step 4, if the phone number information or name information of input SOI data is the same as or similar to that of registered SOI data, geographical information or non-geographical information of new SOI data is merged with registered SOI data, and the merged data is stored in the SOI database at step 5 (S40).

Here, when determining similarity of name information, sub-step 5 (S32) can be implemented to determine similarity using the existing similarity determination algorithm or to determine similarity of name information with reference to synonym dictionary data.

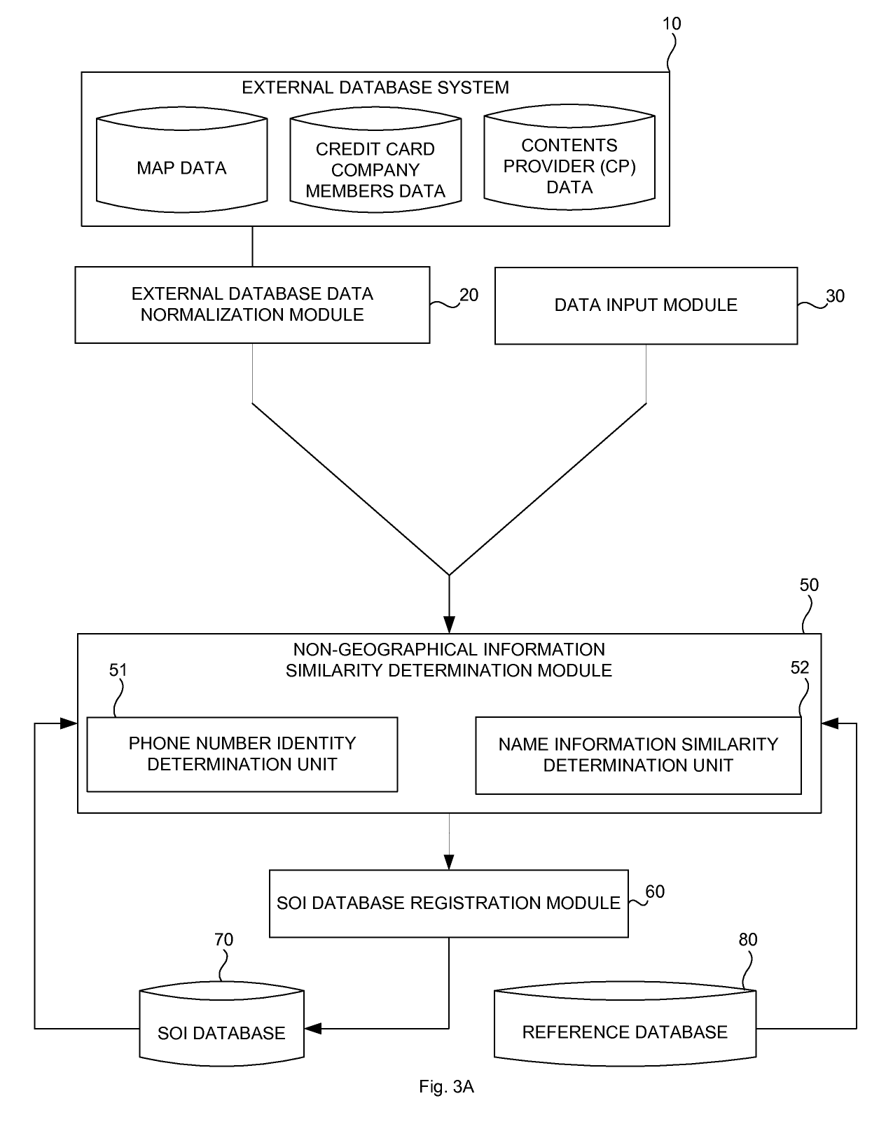

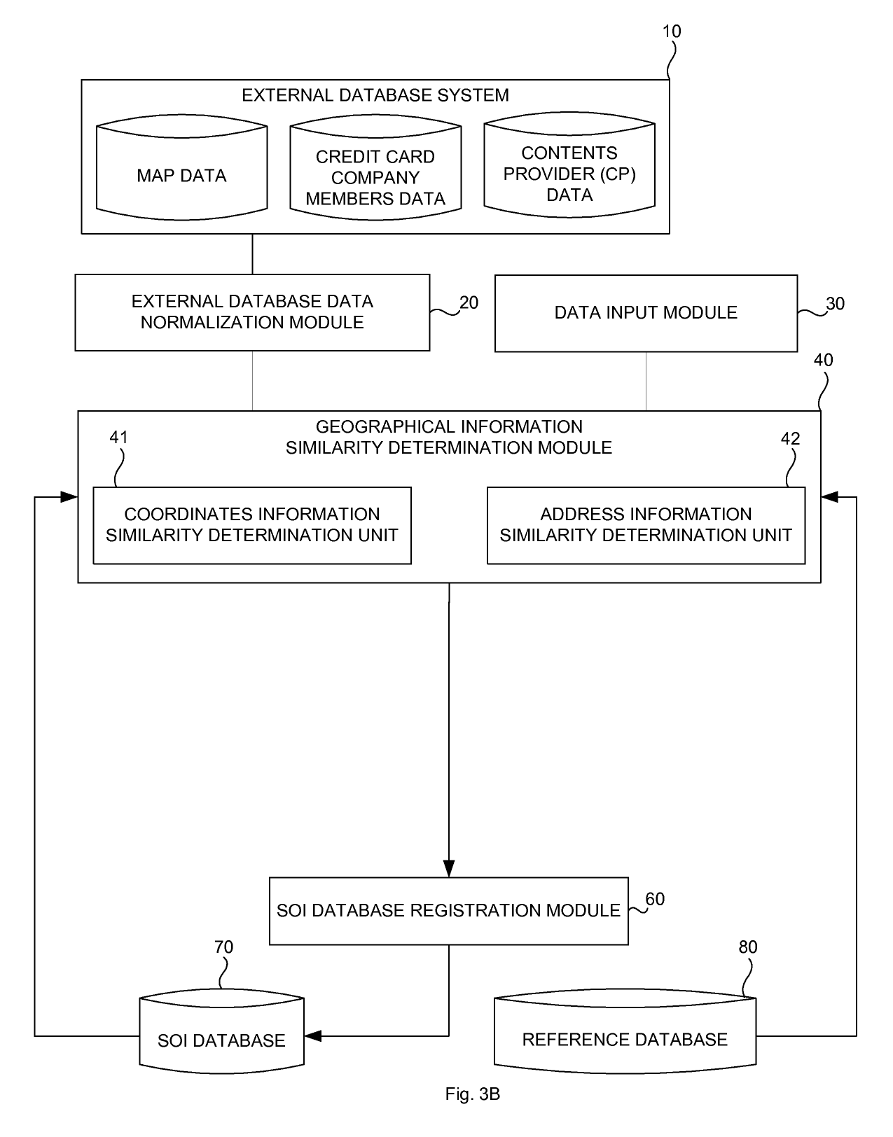

Referring now to FIGS. 3A and 3B, the system described in the context of FIG. 1 can be modified to optionally omit various elements. For example, as depicted in FIG. 3A, geographical information similarity determination module 40 can be optionally omitted so that a similarity determination is exclusively or first made on the basis of non-geographical information. Likewise, as depicted in

FIG. 3B, non-geographical information similarity determination module 50 can be optionally omitted so that a similarity determination is exclusively or first made on the basis of geographical information.

According to an exemplary embodiment of the present invention, when new SOI data is merged with registered SOI data, update into up-to-date information is performed with reference to time information of the data.

According to an exemplary embodiment of the present invention, when merging data, property information of SOI data is updated, added and merged.

The SOI data merged according to the present invention has a hierarchical relationship structure as itself, and thus a relationship structure between the upper SOI and lower SOI of certain SOI is formed, and a relationship structure can be formed with contents.

Here, relationship information and property information for expressing connection relation between SOI and contents are generated and edited, and the relationship information specifically indicates the connection relationship between SOI and contents. For example, it is indicated whether SOI and contents are connected by 1:1, 1:N, N:1 or N:N (here, N is a natural number that is 2 or more). Further, property information more specifically expresses connection relationship between SOI and contents, and for example, the property information is implemented as information that controls the types of the display terminal, list publication, summary display on the screen/contents inquiry, electronic file output, and hardcopy output, etc.

Such relation information and property information also become the subject when updating, adding and merging data.

According to a system for updating SOI data according to an exemplary embodiment of the present invention, the SOI database registration module determines the non-geographical information similarity determination module. As a result, if there is no registered SOI data whose non-geographical information coincides with that of the new SOI data, the new SOI data is stored in the SOI database as new registered SOI data.

Although exemplary embodiments of the present invention have been described in detail hereinabove, it should be clearly understood that many variations and modifications of the basic inventive concepts herein taught that can appear to those skilled in the present art will still fall within the spirit and scope of the present invention, as defined in the appended claims.

What is claimed is:

1. A system for updating space of interest (SOI) data, the system comprising:
an SOI database that stores registered SOI data that is SOI data generated from geographical information;
one or more modules selected from the group consisting of: a data receiving module and an external database, wherein the module that provides new SOI data generated from geographical information;
a geographical information similarity determination module that determines if there is at least one set of registered SOI data whose geographical information is the same as or similar to that of the new SOI data by comparing the geographical information of the new SOI data and the geographical information of the registered SOI data; and
an SOI database registration module that merges the registered SOI data of the SOI database with the geographical information or the non-geographical information of the new SOI data and stores the merged data in the SOI database if there is a set of registered SOI data whose geographical information is the same as or similar to that of the new SOI data as a result of determination of the geographical information similarity determination module.

2. The system of claim 1, wherein the registered SOI data is SOI data generated by mapping geographical information with non-geographical information and the new SOI data is generated by mapping geographical information with non-geographical information.

3. The system of claim 2, further comprising:
a non-geographical information similarity determination module that determines similarity of non-geographical information between the non-geographical information of the new SOI data whose similarity has been confirmed by the geographical information similarity determination module and non-geographical information of the at least one registered SOI data containing the same geographical information.

4. The system of claim 1, wherein the SOI database registration module stores the new SOI data as new registered SOI data in the SOI database if there is no registered SOI data whose geographical information is the same as that of the new SOI data as a result of determination of the geographical information similarity determination module.

5. The system of claim 1, wherein the geographical information includes coordinates information, and
wherein the geographical information similarity determination module further includes a coordinates information similarity determination unit that determines similarity between the coordinates information of the new SOI data and the coordinates information of the registered SOI data.

6. The system of claim 1, wherein the geographical information includes address information, and
wherein the geographical information similarity determination module further includes an address information similarity determination unit that determines similarity between the address information of the new SOI data and the address information of the registered SOI data.

7. The system of claim 1, wherein the geographical information includes coordinates information, and
wherein the geographical information similarity determination module further includes a shape similarity determination unit that determines similarity between a new shape defined by the coordinates information of the new SOI data and an old shape defined by the coordinates information of the registered SOI data.

8. The system of claim 2, wherein the non-geographical information includes phone number information and name information,
wherein the non-geographical information similarity determination module further includes:
a phone number identity determination unit that determines identity between the phone number information of the new SOI data and the phone number information of the registered SOI data and
a name information similarity determination unit that determines similarity between the name information of the new SOI data and the name information of the registered SOI data, and
wherein the SOI database registration module merges the registered SOI data of the SOI database with the geographical information or the non-geographical information of the new SOI data and stores the merged data in the SOI data if there is a set of registered SOI data whose phone number information is the same as that of the new SOI data or whose name information is similar to or the same as that of the new SOI data as a result of determination of the phone number identity determination unit or the name information similarity determination unit.

9. The system of claim 8, wherein the system further comprises a reference database including synonym dictionary data, and
wherein the name information similarity determination unit determines similarity with reference to synonym dictionary data of the reference data.

10. The system of claim 1, wherein the SOI data update system further comprises an external database data normalization module that normalizes input SOI data inputted through the external database system to conform to the data format of the registered SOI data stored in the SOI database.

11. The system of claim 1, wherein the SOI database registration module also merges relation information and property information of SOI data and contents when merging the registered SOI data with the new SOI data.

12. The system of claim 1, wherein the SOI database registration module compares generation time of the registered SOI data with that of the new SOI data and merges recent data when merging the registered SOI data of the SOI database with the new SOI data.

13. The system of claim 1, wherein the new SOI data includes coordinates for a point.

14. The system of claim 11, wherein the geographic information similarity determination module determines if there is at least one set of registered SOI data whose geographic information is the same or similar to that of the new SOI data by determining whether the coordinates for the point lie within a space defined by at least one set of registered SOI data.

15. The system of claim 14, wherein, if the coordinates for the point do not lie within a space defined by at least one set of registered SOI data, the geographic information similarity determination module further determines if there is at least one set of registered SOI data whose geographic information is the same or similar to that of the new SOI data by determining whether the coordinates for the point lie within a buffer surrounding a space defined by at least one set of registered SOI data.

16. The system of claim 14, wherein, if the coordinates for the point do not lie within a space defined by at least one set of registered SOI data, the geographic information similarity determination module further determines if there is at least one set of registered SOI data whose geographic information is the same or similar to that of the new SOI data by determining computing a probability that the point lies within a space defined by at least one set of registered SOI data.

17. The system of claim 1, wherein the new SOI data includes address information.

18. The system of claim 17, wherein the geographic information similarity determination module determines if there is at least one set of registered SOI data whose geographic information is the same or similar to that of the new SOI data by determining whether the address information for the point is the same or similar to address information associated with at least one set of registered SOI data.

19. A system for updating space of interest (SOI) data, the system comprising:
an SOI database that stores registered SOI data that is SOI data generated by mapping geographical information with non-geographical information;
one or more module selected from the group consisting of: (i) a data receiving module and (ii) an external database, wherein the module that provides new SOI data generated from geographical information;
a non-geographical information similarity determination module that determines if there is at least one set of registered SOI data whose non-geographical information is the same as or similar to that of the new SOI data by comparing the non-geographical information of the new SOI data and the non-geographical information of the registered SOI data; and
an SOI database registration module that merges the registered SOI data of the SOI database with the geographical information or the non-geographical information of the new SOI data and stores the merged data in the SOI database if there is a set of registered SOI data whose non-geographical information is the same as or similar to that of the new SOI data as a result of determination of the non-geographical information similarity determination module.

20. The system of claim 19, further comprising:
a geographical information similarity determination module that determines similarity of geographical information between the geographical information of the new SOI data whose similarity has been confirmed by the non-geographical information similarity determination module and geographical information of the at least one registered SOI data containing the same non-geographical information.

21. The system of claim 19, wherein the SOI database registration module stores the new SOI data as new registered SOI data in the SOI database if there is no registered SOI data whose non-geographical information is the same as that of the new SOI data as a result of determination of the non-geographical information similarity determination module.

22. The system of claim 19, wherein the geographical information includes coordinates information, and
wherein the geographical information similarity determination module further includes a coordinates information similarity determination unit that determines similarity between the coordinates information of the new SOI data and the coordinates information of the registered SOI data.

23. The system of claim 19, wherein the geographical information includes address information, and
wherein the geographical information similarity determination module further includes an address information similarity determination unit that determines similarity between the address information of the new SOI data and the address information of the registered SOI data.

24. The system of claim 19, wherein the non-geographical information includes phone number information and name information,
wherein the non-geographical information similarity determination module further includes:
a phone number identity determination unit that determines identity between the phone number information of the new SOI data and the phone number information of the registered SOI data and
a name information similarity determination unit that determines similarity between the name information of the new SOI data and the name information of the registered SOI data, and
wherein the SOI database registration module merges the registered SOI data of the SOI database with the geographical information or the non-geographical information of the new SOI data and stores the merged data in the SOI data if there is a set of registered SOI data whose phone number information is the same as that of the new SOI data or whose name information is similar to or the same as that of the new SOI data as a result of determination of the phone number identity determination unit or the name information similarity determination unit.

25. The system of claim 24, wherein the SOI data update system further comprises a reference database including synonym dictionary data, and
wherein the name information similarity determination unit determines similarity with reference to synonym dictionary data of the reference data.

26. The system of claim 20, wherein the SOI data update system further comprises an external database system including SOI data, and an external database data normalization module that normalizes input SOI data inputted through the external database system to conform to the data format of the registered SOI data stored in the SOI database.

27. The system of claim 20, wherein the SOI database registration module also merges relation information and property information of SOI data and contents when merging the registered SOI data with the new SOI data.

28. The system of claim 20, wherein the SOI database registration module compares generation time of the registered SOI data with that of the new SOI data and merges recent data when merging the registered SOI data of the SOI database with the new SOI data.

29. The system of claim 20, wherein the new SOI data includes coordinates for a point.

30. The system of claim 21, wherein the geographic information similarity determination module determines if there is at least one set of registered SOI data whose geographic information is the same or similar to that of the new SOI data by determining whether the coordinates for the point lie within a space defined by at least one set of registered SOI data.

31. The system of claim 30, wherein, if the coordinates for the point do not lie within a space defined by at least one set of registered SOI data, the geographic information similarity determination module further determines if there is at least one set of registered SOI data whose geographic information is the same or similar to that of the new SOI data by determining whether the coordinates for the point lie within a buffer surrounding a space defined by at least one set of registered SOI data.

32. The system of claim 30, wherein, if the coordinates for the point do not lie within a space defined by at least one set of registered SOI data, the geographic information similarity determination module further determines if there is at least one set of registered SOI data whose geographic information is the same or similar to that of the new SOI data by determining computing a probability that the point lies within a space defined by at least one set of registered SOI data.

33. The system of claim 21, wherein the new SOI data includes address information.

34. The system of claim 33, wherein the geographic information similarity determination module determines if there is at least one set of registered SOI data whose geographic information is the same or similar to that of the new SOI data by determining whether the address information for the point is the same or similar to address information associated with at least one set of registered SOI data.

35. A method for updating SOI data, the method comprising:
receiving an input of input SOI data that is generated by mapping geographical information with non-geographical information (step 1);
determining whether there is a set of registered SOI data containing geographical information that is the same as or similar to that of the input SOI data by comparing the input SOI data with the registered SOI data stored in the SOI database (step 2);
determining if there is a set of data containing geographical information that is the same as or similar to that of the input SOI data as a result of determination of step 2, and otherwise deferring registration of the new SOI data (step 3); and
merging the registered SOI data with the geographical information or non-geographical information of the input SOI data if the geographical information of the input SOI data is the same as or similar to that of the registered SOI data as a result of determination at step 3, and storing the merged data in the SOI database (step 4).

36. The method of claim 35, further comprising:
determining identity or similarity between non-geographical information of the input SOI data whose similarity has been confirmed, and the non-geographical information of the registered SOI data having geographical information that is the same as or similar to that of the input SOI data (step 3b).

37. The method of claim 36, wherein the method further comprises:
storing the input SOI data as new registered SOI data in the SOI database if the non-geographical information of the input SOI data is dissimilar to that of the registered SOI data as a result of determination at step 3b, after step 4 (step 5).

38. The method of claim 35, wherein the geographical information includes coordinates information and address information,
wherein step 2 comprises:
determining whether there is the coordinates information in the input SOI data (sub-step 1);
determining whether there is registered SOI data having coordinates information that is the same as or similar to that of the input SOI data if there is the coordinates in the input SOI data as a result of determination at sub-step 1; and
determining whether there is a set of registered SOI data having the address information that is the same as or similar to that of the new SOI data if there is no coordinates information in the input SOI data as a result of determination at sub-step 1 or if there is no registered SOI data whose coordinates information is the same as or similar to that of the new SOI data as a result of determination at sub-step 2, and
wherein step 3 confirms similarity for the input SOI data if there is a set of registered SOI data whose coordinates information or address information is the same as or similar to that of the input SOI data.

39. The method of claim 37, wherein the non-geographical information includes phone number information and address information,
wherein step 3b comprises:
determining whether there is a set of registered SOI data having phone number information that is the same as that of the input SOI data (sub-step 4); and
determining whether there is a set of registered SOI data having name information that is the same as or similar to that of the input SOI data if there is no registered SOI data having phone number information that is the same as that of the input SOI data as a result of determination at sub-step 4 (sub-step 5), and
wherein step 4 merges the registered SOI data with the geographical information or non-geographical information of the input SOI data, and stores the merged data in the SOI database if the phone number information of the input SOI data is the same as that of the registered SOI data or the name information of the input SOI data is the same as or similar to that of the registered SOI data as a result of determination at step 3b.

40. The method of claim 38, wherein step 4 determines similarity of the name information with reference to synonym dictionary data.

41. The method of claim 36, wherein step 1 further comprises normalizing the input SOI data to conform to the data format of the registered SOI data stored in the SOI database (sub-step 6).

42. A method for updating SOI data, the method comprising:
receiving an input of input SOI data that is generated by mapping geographical information with non-geographical information (step 1);
determining whether there is a set of registered SOI data containing non-geographical information that is the same as or similar to that of the input SOI data by comparing the input SOI data with the registered SOI data stored in the SOI database (step 2);
determining if there is a set of data containing non-geographical information that is the same as or similar to that of the input SOI data as a result of determination of step 2, and otherwise deferring registration of the new SOI data (step 3); and
merging the registered SOI data with the geographical information or non-geographical information of the input SOI data if the non-geographical information of the input SOI data is the same as or similar to that of the registered SOI data as a result of determination at step 3, and storing the merged data in the SOI database (step 4).

43. The method of claim 42, further comprising:
determining identity or similarity between geographical information of the input SOI data whose similarity has been confirmed, and the geographical information of the registered SOI data having non-geographical information that is the same as or similar to that of the input SOI data (step 3b).

44. The method of claim 43, wherein the method further comprises:
storing the input SOI data as new registered SOI data in the SOI database if the geographical information of the input SOI data is dissimilar to that of the registered SOI data as a result of determination at step 3b, after step 4 (step 5).

45. The method of claim 43, wherein the geographical information includes coordinates information and address information,
wherein step 2 comprises:
determining whether there is the coordinates information in the input SOI data (sub-step 1);
determining whether there is registered SOI data having coordinates information that is the same as or similar to that of the input SOI data if there is the coordinates in the input SOI data as a result of determination at sub-step 1; and
determining whether there is a set of registered SOI data having the address information that is the same as or similar to that of the new SOI data if there is no coordinates information in the input SOI data as a result of determination at sub-step 1 or if there is no registered SOI data whose coordinates information is the same as or similar to that of the new SOI data as a result of determination at sub-step 2, and
wherein step 3 confirms similarity for the input SOI data if there is a set of registered SOI data whose coordinates information or address information is the same as or similar to that of the input SOI data.

46. The method of claim 42, wherein the geographical information includes phone number information and address information,
wherein step 3 comprises:
determining whether there is a set of registered SOI data having phone number information that is the same as that of the input SOI data (sub-step 4); and
determining whether there is a set of registered SOI data having name information that is the same as or similar to that of the input SOI data if there is no registered SOI data having phone number information that is the same as that of the input SOI data as a result of determination at sub-step 4 (sub-step 5),
wherein step 4 merges the registered SOI data with the geographical information or non-geographical information of the input SOI data, and stores the merged data in the SOI database if the phone number information of the input SOI data is the same as that of the registered SOI data or the name information of the input SOI data is the same as or similar to that of the registered SOI data as a result of determination at step 3.

47. The method of claim 42, wherein step 3 determines similarity of the name information with reference to synonym dictionary data.

48. The method of claim 42, wherein step 1 further comprises normalizing the input SOI data to conform to the data format of the registered SOI data stored in the SOI database (sub-step 6).

49. A method for updating SOI data, the method comprising:
receiving an input of input SOI data that is generated by mapping geographical information with non-geographical information (step 1);
determining whether there is a set of registered SOI data containing geographical and non-geographical information that is the same as or similar to that of the input SOI data by comparing the input SOI data with the registered SOI data stored in the SOI database (step 2); and
merging the registered SOI data with the geographical information or non-geographical information of the input SOI data if the geographical information and non-geographical information of the input SOI data is the same as or similar to that of the registered SOI data as a result of determination at step 2, and storing the merged data in the SOI database (step 3).

50. A system for updating space of interest (SOI) data, the system comprising:
an SOI database that stores registered SOI data that is SOI data generated by mapping geographical information with non-geographical information;
one or more module selected from the group consisting of: (i) a data receiving module and (ii) an external database, wherein the module that provides new SOI data generated from geographical information;
an information similarity determination module that determines if there is at least one set of registered SOI data whose geographical information and non-geographical information is the same as or similar to that of the new SOI data by comparing the geographical information and non-geographical information of the new SOI data and the geographical information and non-geographical information of the registered SOI data; and
an SOI database registration module that merges the registered SOI data of the SOI database with the geographical information or the non-geographical information of the new SOI data and stores the merged data in the SOI database if there is a set of registered SOI data whose geographical information and non-geographical information is the same as or similar to that of the new SOI data as a result of determination of the information similarity determination module.

51. A computer program product for causing a computer to perform a method for updating SOI data, the computer program product comprising computer-usable medium having control logic stored therein that, when executed by a processor, is operable to:
receive an input of input SOI data that is generated by mapping geographical information with non-geographical information (step 1);
determine whether there is a set of registered SOI data containing geographical information that is the same as or similar to that of the input SOI data by comparing the input SOI data with the registered SOI data stored in the SOI database (step 2);
determine if there is a set of data containing geographical information that is the same as or similar to that of the input SOI data as a result of determination of step 2, and otherwise deferring registration of the new SOI data (step 3); and
merge the registered SOI data with the geographical information or non-geographical information of the input SOI data if the geographical information of the input SOI data is the same as or similar to that of the registered SOI data as a result of determination at step 3, and storing the merged data in the SOI database (step 4).

52. A computer program product for causing a computer to perform a method for updating SOI data, the computer program product comprising computer-usable medium having control logic stored therein that, when executed by a processor, is operable to:
receive an input of input SOI data that is generated by mapping geographical information with non-geographical information (step 1);
determine whether there is a set of registered SOI data containing non-geographical information that is the same as or similar to that of the input SOI data by comparing the input SOI data with the registered SOI data stored in the SOI database (step 2);
determine if there is a set of data containing non-geographical information that is the same as or similar to that of the input SOI data as a result of determination of step 2, and otherwise deferring registration of the new SOI data (step 3); and
merge the registered SOI data with the geographical information or non-geographical information of the input SOI data if the non-geographical information of the input SOI data is the same as or similar to that of the registered SOI data as a result of determination at step 3, and storing the merged data in the SOI database (step 4).

53. A computer program product for causing a computer to perform a method for updating SOI data, the computer program product comprising computer-usable medium having control logic stored therein that, when executed by a processor, is operable to:
receive an input of input SOI data that is generated by mapping geographical information with non-geographical information (step 1);
determine whether there is a set of registered SOI data containing geographical and non-geographical information that is the same as or similar to that of the input SOI data by comparing the input SOI data with the registered SOI data stored in the SOI database (step 2); and
merge the registered SOI data with the geographical information or non-geographical information of the input SOI data if the geographical information and non-geographical information of the input SOI data is the same as or similar to that of the registered SOI data as a result of determination at step 2, and storing the merged data in the SOI database (step 3).
